(19) United States
(12) Patent Application Publication
(10) Pub. No.: US 2016/0107015 A1
(43) Pub. Date: Apr. 21, 2016

(54) FIRE EXTINGUISHING COMPOSITION AND GEL-STATE FIRE EXTINGUISHING MATERIAL CONTAINING THE SAME

(71) Applicant: Chang-Wu Cheng, Taipei City (TW)

(72) Inventor: Chang-Wu Cheng, Taipei City (TW)

(21) Appl. No.: 14/520,157

(22) Filed: Oct. 21, 2014

(51) Int. Cl. A62D 1/06; A62D 1/00

(52) U.S. Cl. CPC A62D 1/06; A62D 1/0064

(57) ABSTRACT

There is provided a fire extinguishing composition which comprises a foaming agent, an emulsifier, sodium dodecylbenzenesulfonate, and polyphosphate. There is also provided a gel-state fire extinguishing material which is formulated by mixing the fire extinguishing composition with water. In use, the gel-state fire extinguishing material is diluted with an additional amount of water.

### FIELD OF THE INVENTION

The invention relates to a fire extinguishing composition, more particularly to a fire extinguishing composition adapted for mixing with water to form a gel-state fire extinguishing material. The invention also relates to the gel-state fire extinguishing material.

### BACKGROUND OF THE INVENTION

Fire starts when a flammable and/or combustible material (for example, fuel) in combination with a sufficient quantity of an oxidizer (such as oxygen gas or another oxygen-rich compound) is exposed to a source of heat or an ambient temperature above a flash point of the combination of the flammable and/or combustible material and the oxidizer. Fire can be extinguished by removing anyone of the aforesaid elements causing the fire. Common ways of extinguishing fire includes: (1) isolating the flammable and/or combustible material from the oxidizer, and (2) lowering the temperature of the burning material below the flash point thereof.

One of the most common ways of extinguishing fire nowadays is to spray air-pressurized water onto the burning material so as to lower the temperature of the burning material below the flash point thereof and to form a water film to isolate air from the burning material. However, as water cannot stay on the burning material due to flowability of water, a large amount of water is required to prevent the fire from spreading. Therefore, the fire extinguishing effect is limited.

Other ways of extinguishing fire include use of a dry powder or foam. However, when the dry powder or foam is sprayed onto the burning material, it will rapidly evaporate due to heat or flame radiation produced by the burning material. Additionally, when the dry powder or foam is sprayed onto a burning wall, the dry powder or foam is liable to fall down along the wall so that the burning material cannot be effectively isolated from the oxidizer (i.e., air). Thus the fire extinguishing effect is limited. Furthermore, the dry powder or foam is liable to scatter during the fire to result in pollution problems.

### SUMMARY OF THE INVENTION

Therefore, an object of the present invention is to provide a fire extinguishing composition so as to overcome the above-mentioned drawbacks of the prior art.

According to an aspect of this invention, there is provided a fire extinguishing composition adapted for mixing with water to form a gel-state fire extinguishing material. The composition comprises a foaming agent, an emulsifier, sodium dodecylbenzenesulfonate, and polyphosphate.

According to another aspect of this invention, there is provided a gel-state fire extinguishing material which comprises a foaming agent, an emulsifier, sodium dodecylbenzenesulfonate, polyphosphate, and water.

### DETAILED DESCRIPTION OF THE EMBODIMENT

The fire extinguishing composition of this invention is adapted for mixing with water to form a gel-state fire extinguishing material. The fire extinguishing composition comprises a foaming agent, an emulsifier, sodium dodecylbenzenesulfonate, and polyphosphate.

Preferably, the foaming agent is in an amount ranging from 5 to 100 parts by weight, the emulsifier is in an amount ranging from 0.5 to 1.5 parts by weight, the sodium dodecylbenzenesulfonate is in an amount ranging from 15 to 30 parts by weight, and the polyphosphate is in an amount ranging from 30 to 200 parts by weight based on 1000 parts by weight of water.

The aforesaid components contained in the fire extinguishing composition of this invention are safe chemical materials recognized by international safety organizations, and are basically not harmful to the environment.

In use, the foaming agent will react with water to produce a gas which remains in a bubble form within the gel-state fire extinguishing material so that the effect of isolating a burning material from air and lowering the temperature of the burning material may be enhanced.

Sodium dodecylbenzenesulfonate is an anionic surfactant, has good emulsifying and foaming properties, and is not easy to oxidize.

Polyphosphate is a water-retaining agent with strong hydrophilicity so that water can be retained in the gel-state fire extinguishing material thereby when the gel-state fire extinguishing material is prepared, thus enhancing the fire extinguishing effect. Additionally, polyphosphate may be used as an inorganic surfactant, is capable of emulsification, and can enhance the dispersion of the other components in water to form the gel-state fire extinguishing material.

The emulsifier useful in this invention is selected from non-ionic surfactants, and is preferably selected from oxyalkylated compounds.

When the fire extinguishing composition of this invention prepared by combining the foaming agent, the emulsifier, sodium dodecylbenzenesulfonate, and polyphosphate is added to water, a gel-state fire extinguishing material retaining a large amount of water can be obtained.

It the fire extinguishing composition of this invention is intended to be used in a temperate region, it may further comprise an anti-freezing agent so as to prevent freezing of the fire extinguishing composition and so as not to affect the fire extinguishing performance in use. The anti-freezing agent is used in an amount preferably ranging from 50 to 200 parts by weight based on 1000 parts by weight of water. Preferably, the anti-freezing agent useful in this invention is selected from ethylene glycol, propylene glycol, diethylene glycol, polyethylene glycol, and combinations thereof. More preferably, propylene glycol is used as the anti-freezing agent for purposes of environmental protection.

A gel-state fire extinguishing material of this invention is formulated by adding the aforesaid fire extinguishing composition of this invention to water in a manner such that the foaming agent is in an amount ranging from 5 to 100 parts by weight, the emulsifier is in an amount ranging from 0.5 to 1.5 parts by weight, the sodium dodecylbenzenesulfonate is in an amount ranging from 15 to 30 parts by weight, and the polyphosphate is in an amount ranging from 30 to 200 parts by weight based on 1000 parts by weight of water.

The gel-state fire extinguishing material of this invention may optionally further comprise the anti-freezing agent in an amount preferably ranging from 50 to 200 parts by weight based on 1000 parts by weight of water.

The gel-state fire extinguishing material of this invention is formulated by stirring the foaming agent, the emulsifier, sodium dodecylbenzenesulfonate, polyphosphate, and optionally the anti-freezing agent in the aforesaid amounts at a stirring rate of about 60 r.p.m. at a temperature of not higher than 60° C.

In use, the gel-state fire extinguishing material of this invention is diluted with water in a volume amount ranging from 10 to 20 times a volume amount of the gel-state fire extinguishing material. Therefore, the apace for storing and transporting the gel-state fire extinguishing material may be effectively reduced.

The following example is provided to illustrate the preferred embodiment of the invention, and should not be construed as limiting the scope of the invention.

### EXAMPLE 1

5 g of a foaming agent, 0.5 g of an alkylated nonionic emulsifier, 15 g of sodium dodecylbenzenesulfonate, and 30 g of polyphosphate are added to 1000 ml of water followed by stirring to obtain a composition. 50 g of an anti-freezing agent is then added to the composition, followed by further stirring to obtain a gel-state fire extinguishing material, which is useful in a region having an environmental temperature ranging from −40° C. to 40° C.

In view of the aforesaid, the following effects may be obtained by the fire extinguishing composition and the gel-state fire extinguishing material of this invention:

1. When the gel-state fire extinguishing material of this invention formulated by mixing the fire extinguishing composition of this invention with water is used for extinguishing fire, the gel-state fire extinguishing material retaining a large amount of water can effectively adhere to and cover the burning material for an extended period of time so that the burning material may be effectively isolated from the oxidizer, and the temperature of the burning material may be effectively lowered so as to enhance the fire extinguishing effect.

2. The foaming agent, the emulsifier, sodium dodecylbenzenesulfonate, and polyphosphate used in the fire extinguishing composition of this invention are safe chemical materials recognized by international safety organizations and are non-corrosive, and are thus not harmful to the environment.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. Afire extinguishing composition adapted for mixing with water to form a gel-state fire extinguishing material, said composition comprising: a foaming agent, an emulsifier, sodium dodecylbenzenesulfonate, and polyphosphate.

2. The fire extinguishing composition according to claim 1, wherein said foaming agent is in an amount ranging from 5 to 100 parts by weight, said emulsifier is in an amount ranging from 0.5 to 1.5 parts by weight, said sodium dodecylbenzenesulfonate is in an amount ranging from 15 to 30 parts by weight, and said polyphosphate is in an amount ranging from 30 to 200 parts by weight based on 1000 parts by weight of water.

3. The fire extinguishing composition according to claim 1, wherein said emulsifier is a nonionic surfactant selected from alkoxylated compounds.

4. The fire extinguishing composition according to claim 1, further comprising an anti-freezing agent in an amount ranging from 50 to 200 parts by weight based on 1000 parts by weight of water.

5. The fire extinguishing composition according to claim 4, wherein said anti-freezing agent is selected from the group consisting of ethylene glycol, propylene glycol, diethylene glycol, polyethylene glycol, and combinations thereof.

6. A gel-state fire extinguishing material comprising:
a foaming agent, an emulsifier, sodium dodecylbenzenesulfonate, polyphosphate, and water.

7. The gel-state fire extinguishing material according to claim 6, wherein said foaming agent is in an amount ranging from 5 to 100 parts by weight, said emulsifier is in an amount ranging from 0.5 to 1.5 parts by weight, said sodium dodecylbenzenesulfonate is in an amount ranging from 15 to 30 parts by weight, and said polyphosphate is in an amount ranging from 30 to 200 parts by weight based on 1000 parts by weight of said water.

8. The gel-state fire extinguishing material according to claim 6, further comprising an anti-freezing agent.

9. The gel-state fire extinguishing material according to claim 8, wherein said anti-freezing agent is in an amount ranging from 50 to 200 parts by weight based on 1000 parts by weight of said water.
